(19) United States
(12) Patent Application Publication
(10) Pub. No.: US 2004/0165391 A1
(43) Pub. Date: Aug. 26, 2004

(54) METHOD AND APPARATUS FOR LINEAR LAMP IRRADIANCE CORRECTION

(75) Inventors: Allen P. Blacker JR., Hoffman Estates, IL (US); Thomas Becker, Valparasio, IN (US)

Correspondence Address: BABCOCK IP LLC, 24154 LAKESIDE DRIVE, LAKE ZURICH, IL, 60047, US

(73) Assignee: AETEK UV SYSTEMS, INC., Romeovile, IL (US)

(21) Appl. No.: 10/248,807

(22) Filed: Feb. 20, 2003

(51) Int. Cl. F21V 7/00

(52) U.S. Cl. 362/346; 362/216; 362/217; 362/347; 362/260

(57) ABSTRACT

Linear lamp energy output is tuned by adjusting the reflectivity of reflectors or shade members used to direct, focus and filter energy output of a linear bulb. Reflectivity is reduced in areas of the reflector contributing to high irradiance levels in a target area allowing, for example, overall equalization of irradiance across the target area. An outer surface of the linear bulb may have a modified diameter, light transmission reducing surface treatment or an added sleeve to linear bulb areas contributing to irradiance levels in specific locations in the target area that are higher than desired. Alternatively and or additionally, a lens or shade member having a graduated convergence, reflectivity and or transmisivity may be used.

### BACKGROUND OF INVENTION

1. Field of the Invention

The present invention generally relates to a method and apparatus for configuring the light output of a linear lamp. More specifically, the present invention enables tuning of irradiance distribution on a target area generally corresponding to a-linear lamp's longitudinal dimension.

2. Description of Related Art

Linear lamps typically have a housing that functions as a support structure for reflector(s) and a linear bulb. Linear bulbs may be configured to emit a broad spectrum of energy or be tuned to a specific band of energy wavelengths for example ultraviolet and or infrared. Many forms of linear bulbs exist, for example, arc bulbs, microwave bulbs, incandescent bulbs and resistive heat elements.

An arc bulb contains an ionizing gas in a, for example, cylindrical quartz enclosure with electrodes at either end. When an electrical potential is applied across the electrodes, a high intensity light emitting plasma is formed between the electrodes. The, for example, parabolic or elliptical reflector(s) redirects and or focuses the arc bulb's light output upon a desired target area.

Microwave bulbs also contain an ionizing gas in a, for example cylindrical quartz enclosure. The gas is excited into an energy emitting plasma by exposure to microwave energy generated, for example, by one or more magnetrons.

Linear lamps are commonly used as a high intensity energy sources in, for example, polymerization processes using ultraviolet light cured/activated inks, varnishes, resins or adhesives printed or coated upon films, 3D objects, composite structures or other substrates. The films or other substrates may be formed in a continuous web that is passed under one or more linear lamps at a distance and rate configured to expose the web to a desired irradiance. Alternatively, individual articles may be placed on a conveyor for passage under or through an array of linear lamp(s).

Energy, for example plasma, generally has an omni-directional radiation characteristic, i.e. each point of the plasma radiates its energy output omni-directionally. Along a longitudinal target area below the length of the linear bulb and any reflector, points on the target area proximate the middle of the plasma receive an energy contribution from points to either side, along the plasma. However, towards either end of the target area (below either end of the plasma), the target area receives less irradiance because those points receive an additional energy contribution only from points towards the middle of the plasma, unless the linear lamp is dimensioned to extend significantly beyond the target area. This results in a linear lamp generating an irradiance profile in a non-uniform distribution upon the longitudinal target area with a peak beneath the center of the linear bulb. If it is not practical to use a linear bulb that extends significantly beyond the desired web and or conveyor width, multiple linear bulbs have been used in a staggered, overlapping or end to end configuration. However, to minimize equipment and maintenance costs, a single linear bulb and housing is advantageous.

To maximize process throughput and or enable processing of articles with larger dimensions, wider webs and or conveyors are desired. However, where the process requires a high level of irradiance uniformity across the web and or conveyor and the desired web and or conveyor width approaches the length of available cost efficient linear bulbs, using a linear bulb has previously failed to provide satisfactory irradiance uniformity.

Depending on the process, the reflector(s) may become fouled over time by condensation, volatile vapors, fumes and or particulates associated with the process that degrades the reflectivity of the reflector(s) to a point where they no longer reflect at a level that maintains the desired irradiance across the web and or conveyor, requiring regular maintenance/replacement. Isolation of the reflectors from the process, for example through the addition of a protective window and or transparent filter adds to the cooling demands of the energy radiation system and only shifts the fouling problem to the protective window or transparent filter, which may be more expensive than a reflector in the form of a simple metallic insert. Therefore, it is desirable that reflectors be readily exchangeable and inexpensive.

Competition within the linear lamp and energy curing industries has focused attention upon minimization of equipment, operations and replacement part costs.

Therefore, it is an object of the present invention to provide a method and apparatus that overcomes deficiencies in the prior art.

### BRIEF DESCRIPTION OF DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is an isometric view of a linear lamp according to a first embodiment of the invention.

FIG. 2a is a chart showing a prior art linear lamp arrangement having a common reflectivity reflector, a standard radiance profile linear bulb and the resulting irradiance profile at a target area.

FIG. 2b1 is a chart showing a linear lamp arrangement according to a first embodiment of the invention having a varied reflectivity reflector (wide segments), a standard radiance profile linear bulb and the resulting irradiance profile at a target area.

FIG. 2b2 is a chart showing a linear lamp arrangement according to an alternative embodiment of the invention having a varied reflectivity reflector (for example narrow segments or non-segmented reflector with optimized reflectivity profile), a standard radiance profile linear bulb and the resulting irradiance profile at a target area.

FIG. 2c is a chart showing a linear lamp arrangement according to an alternative embodiment of the invention having a common reflectivity reflector, a varied radiance profile linear bulb and the resulting irradiance profile at a target area.

FIG. 2d is a chart showing a linear lamp arrangement according to an alternative embodiment of the invention having a varied reflectivity reflector, a varied radiance profile linear bulb and the resulting irradiance profile at a target area.

FIG. 2e is a chart showing a linear lamp arrangement according to an alternative embodiment of the invention having a common reflectivity reflector, a standard radiance profile linear bulb, a shade having a varied transmission/reflectivity profile and the resulting irradiance profile at a target area.

FIG. 2f is a chart showing a linear lamp arrangement according to an alternative embodiment of the invention having a common reflectivity reflector and a graded optical focusing system arranged to selectively defocus output of a standard radiance profile linear bulb and the resulting irradiance profile at a target area.

FIG. 3 is a top schematic view of a linear lamp reflector segment with a low reflectivity pattern according to a second embodiment of the invention.

FIG. 4 is a top schematic view of a linear lamp reflector segment with a low reflectivity pattern according to a third embodiment of the invention.

FIG. 5 is a top schematic view of a linear lamp reflector segment with a low reflectivity pattern according to a fourth embodiment of the invention.

FIG. 6 is a top schematic view of a linear lamp reflector segment with a low reflectivity pattern according to a fifth embodiment of the invention.

FIG. 7 is a top schematic view of a linear lamp reflector segment with a low reflectivity pattern according to a sixth embodiment of the invention.

FIG. 8 is a top schematic view of a linear lamp reflector segment with a low reflectivity pattern according to a seventh embodiment of the invention.

FIG. 9 is a top schematic view of a linear lamp reflector with a low reflectivity pattern according to a eighth embodiment of the invention.

FIG. 10 is a top schematic view of a linear lamp reflector with a low reflectivity pattern according to a ninth embodiment of the invention.

FIG. 11 is a top schematic view of a linear bulb with a low reflectivity pattern according to a tenth embodiment of the invention.

FIG. 12 is a top schematic view of a linear bulb with a low reflectivity pattern according to an eleventh embodiment of the invention.

FIG. 13 is a top schematic view of a linear bulb with a varied diameter according to a twelfth embodiment of the invention.

FIG. 14 is a top schematic view of a linear bulb with a varied diameter according to a thirteenth embodiment of the invention.

FIG. 15 is a top schematic view of a shade member with a low reflectivity pattern according to a fourteenth embodiment of the invention.

FIG. 16 is a top schematic view of a shade member with a low reflectivity pattern according to a fifteenth embodiment of the invention.

FIG. 17 is an isometric view of a lens according to a sixteenth embodiment of the invention.

### DETAILED DESCRIPTION

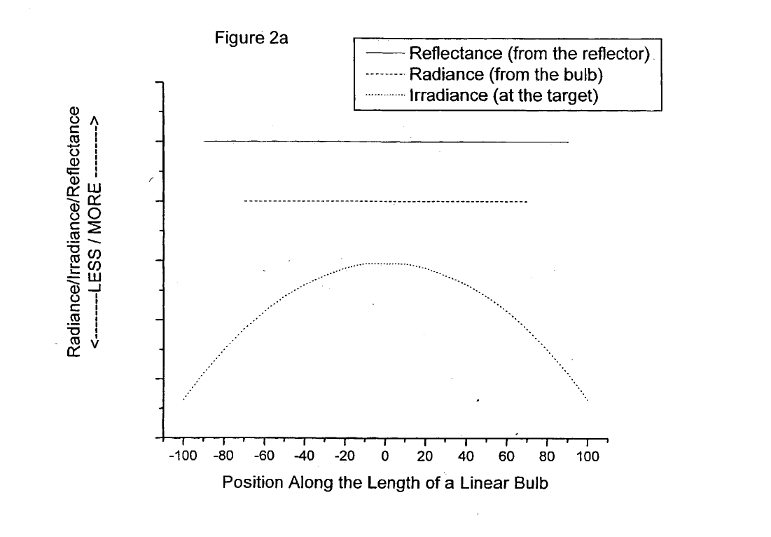

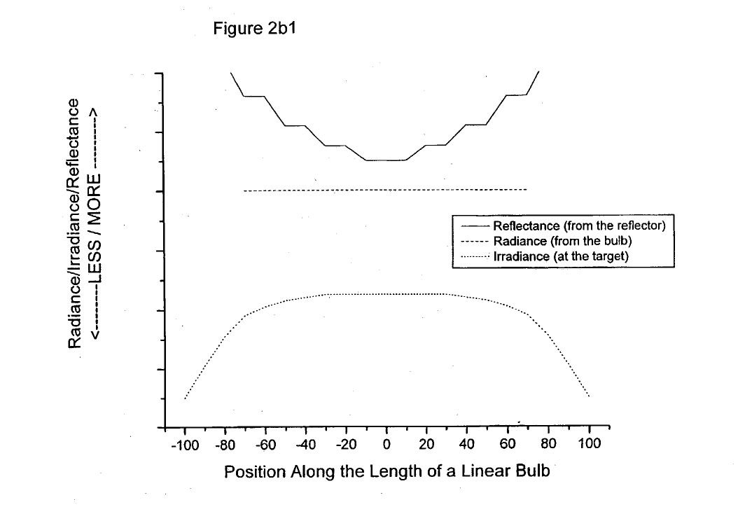

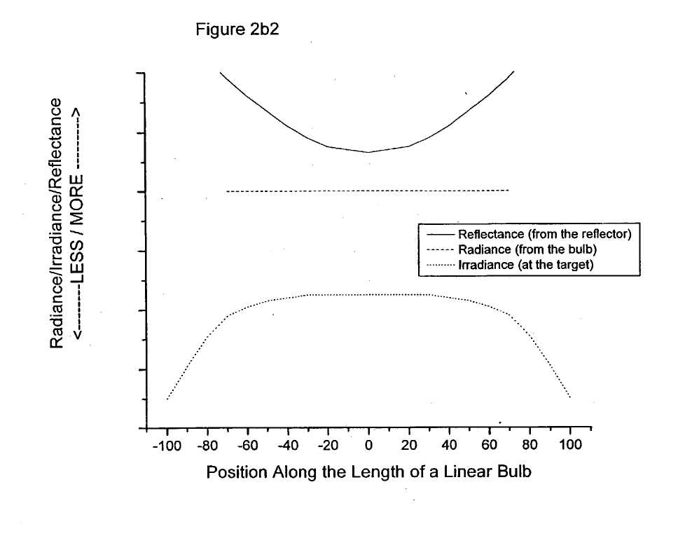

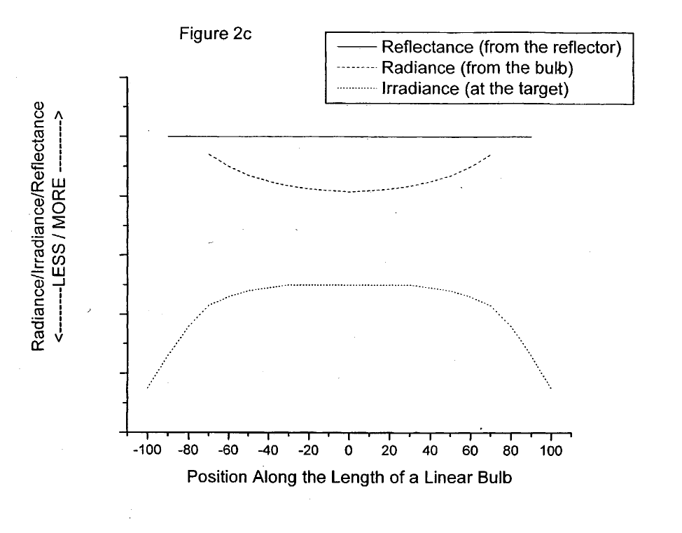

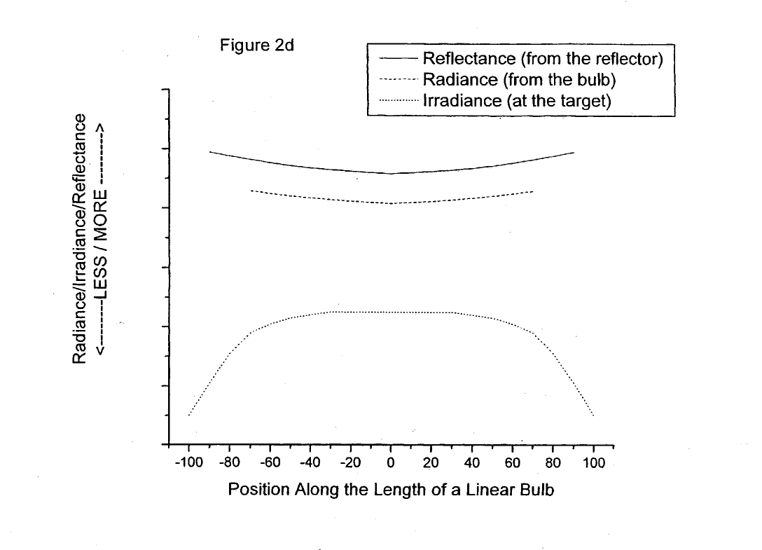

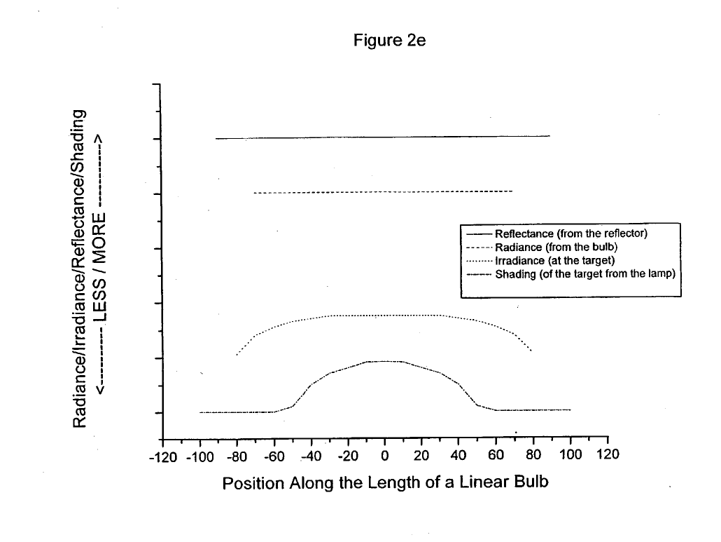

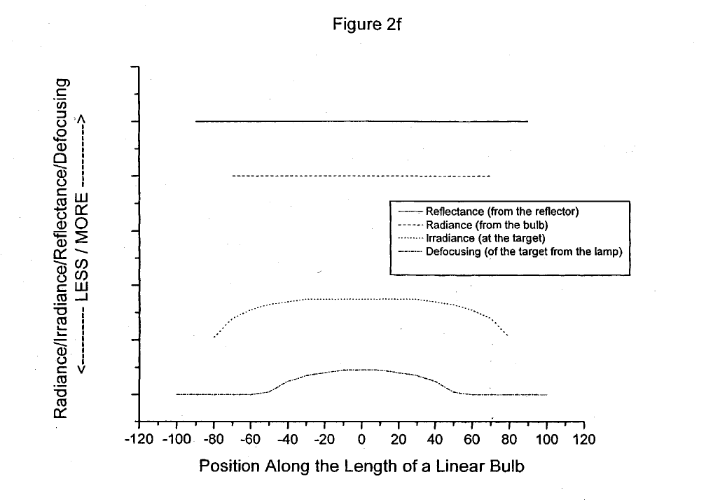

Prior linear lamps utilize a reflector(s) having a common reflectivity along its longitudinal length. The reflector(s) may be configured to be easily removed for replacement upon fouling. For example, the reflector surfaces may be slid into place along a retaining/aligning guide channel. FIG. 2a is a chart showing characteristics of the typical prior art linear lamp arrangement. Along a longitudinal target area relative the length of the linear bulb, these characteristics generate a curved irradiance profile with a peak proximate the middle of the bulb. An example of the prior art using an arc bulb is the arc lamp model UVXL manufactured by AETEK UV Systems of Romeoville, Ill.

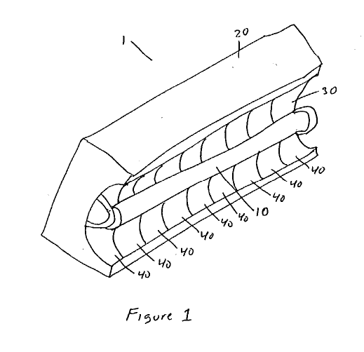

As shown in FIG. 1, a linear lamp 1 has a linear bulb 10 supported at either end mounted in a lamp housing 20. A reflector 30 is positioned proximate the linear bulb 10 to redirect the linear bulb 10 energy output into a desired target area. The reflector 30 may also be configured as two or more reflectors 30, the reflectors 30 may also be movable to isolate the linear bulb 10 energy output from the target area during process initiation, interruption and or completion.

The reflector 30 of a first embodiment of the invention is configured as a plurality of reflector segments 40. Each reflector segment 40 may be selected from a range of materials having different reflectivity coefficients and or a common material having a range of different surface treatments resulting in different reflectivity coefficients. The reflector segments 40 may be installed into the linear lamp 1 via the guide channel, end to end. For example, by selecting the reflector segments 40 to have a lower reflectivity at the center of the housing 20 and a higher reflectivity towards either end, the bell curve light output characteristic of a linear lamp may be tuned to reduce the center peak. FIG. 2b1 is a variation of FIG. 2a, showing the characteristics of the first embodiment, arranged to reduce the center peak.

The reflector segments 40 utilized in the example above may comprise 4 inch wide segments of, for example, either the high specular reflectivety “A” or low specular reflectivety “U” side of Alzac (Specular 2000 available from “Alanod” Aluminium-Veredlung GmbH & Co.KG, Germany) and ASTM B370 Copper “C” material in the following order: A-A-A-U-C-U-U-C-U-A-A-A. Segments at either end may be adapted to the exact length of the reflector housing.

Other materials having different reflectivity characteristics, surface finishes and or segment dimensions may be readily substituted by one skilled in the art to obtain a desired irradiance characteristic across a desired target area.

In alternative embodiments as shown in FIGS. 3-8, a low reflectivity pattern of, for example, dots or lines may be applied to the reflector segments 40 surface area to achieve a similar result. The surface pattern may be created by perforating, mechanically roughing the reflective surface and or by applying low reflectivity coating (s) of, for example, carbon black. Any pattern that lowers the reflectivity to a desired level may be used.

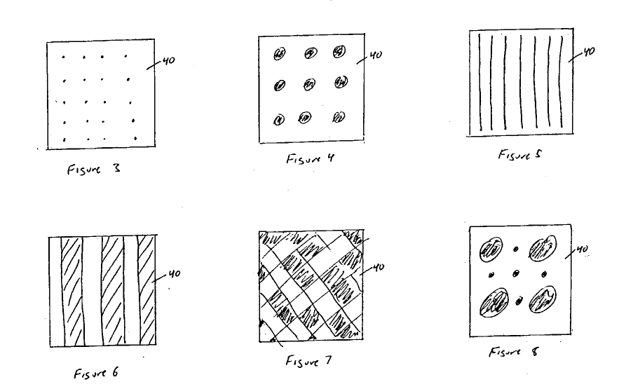

A collection of reflector segments 40 having a range of low to high reflectivity patterns and or materials with a similar range of reflectivity's allows tuning of a linear lamp's 1 light output to a specific desired irradiance profile. To increase the tuning irradiance profile specificity, shorter width reflector segments 40 may be used. If reflector segments 40 having a very small width are used, reflector segments 40 of only two types, a high reflectivity type and a low reflectivity type, may be used to configure a desired reflectivity by alternating the high and low reflectivity reflector segments 40 in combinations resulting in a desired reflectivity average that changes across the longitudinal dimension of the linear bulb 10 they are mated with. Also, if a specific configuration of reflectivity levels across a reflector surface is selected, a pattern of the, for example, dots and or lines may be applied to a single reflector 30, as shown in FIGS. 9 and 10. FIG. 2b2 is a variation of FIG. 2a, showing the characteristics of alternative embodiments where the reflectivity profile is evenly graduated, arranged to reduce the center peak.

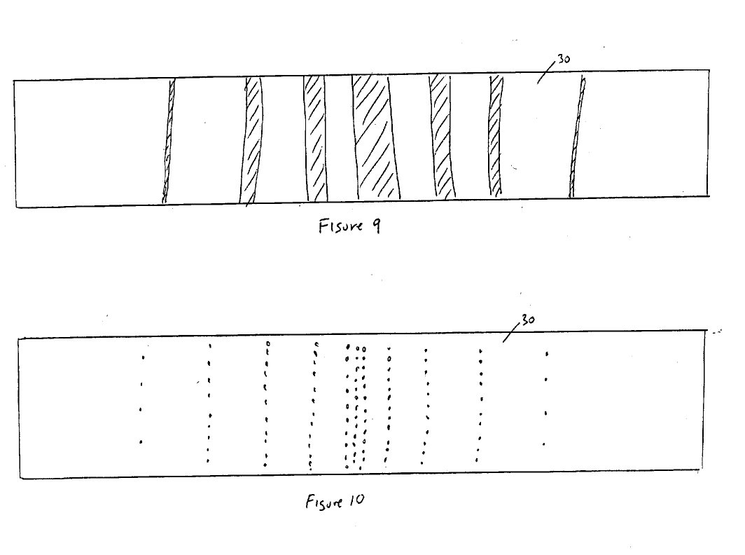

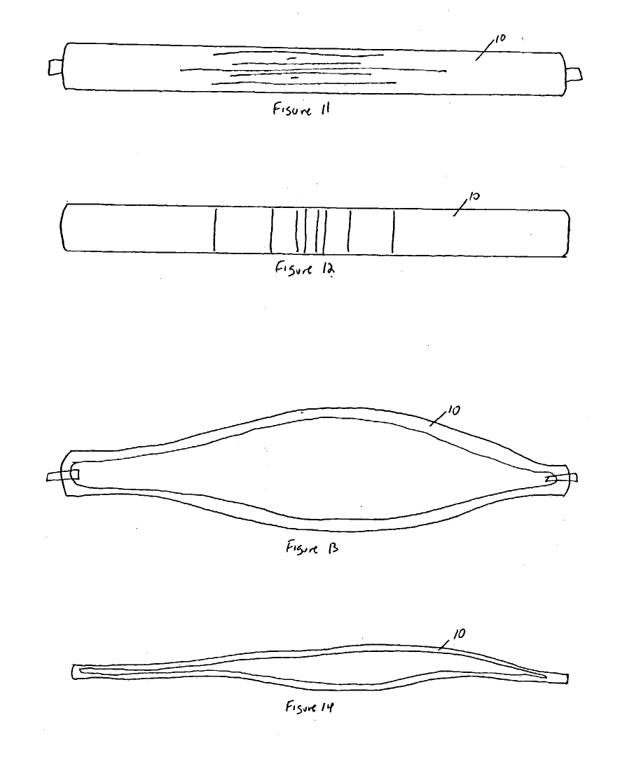

In a further embodiment, as shown in FIGS. 11 and 12, a surface treatment, coating and or sleeve may be applied to the outer and or inner surfaces of the linear bulb 10. In this embodiment, the surface treatment, coating and or sleeve should be capable of withstanding the extreme temperatures present on the linear bulb's 10 surface without compromising the linear bulb's 10 integrity. Alternatively, as shown in FIGS. 13 and 14, the linear bulb's diameter may be varied along its length. For example, a smaller diameter towards either end and a larger diameter in a middle section may be used to lower the linear bulb's radiance in the middle section and increase it towards either end. FIG. 2c is a variation of FIG. 2a, showing the characteristics of alternative embodiments where the radiance profile of the linear bulb is reduced towards the center of the linear bulb.

Further, the variations to the reflector reflectivity profile and the radiance profile of the linear bulb described herein may be combined to arrive at, for example, the irradiance profile shown in FIG. 2d.

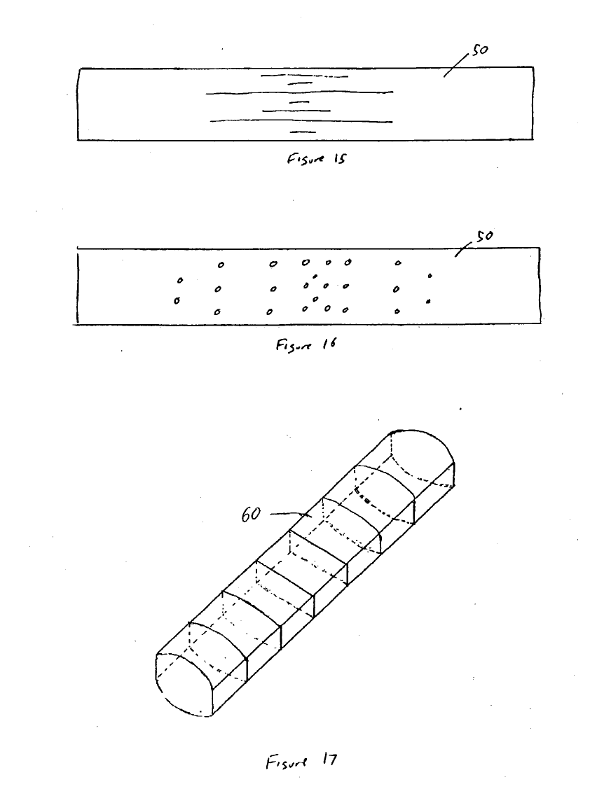

FIGS. 15 and 16 show examples of shade members 50 usable with a linear lamp according to the present invention. U.S. utility patent application Ser. No. 10/164,620, “UV curing system for heat sensitive substances” filed Jun. 10, 2002 by Allen P. Blacker et al, hereby incorporated by reference in its entirety, describes shade members and or dichroic reflector coatings usable with UV linear lamps which have the effect of lowering the level of thermal exposure the substance(s) being cured receive. A pattern of low reflectivity/transmission created on the shade member 50 may also be used according to the present invention to adjust the irradiance profile at a target area along corresponding to the length of the linear lamp. As described herein above, a low reflectivity/transmission pattern may be formed by, for example, selectively modifying the shade member 50 surface characteristics and or adding a low reflectivity pattern to desired areas of the shade member 50, resulting in a linear lamp having characteristics, for example, as shown in FIG. 2e. A shade member 50 as described herein may be combined with reflectors 30 and or multiple reflector segments 40 also according to the present invention.

Alternatively as shown by FIG. 17, a lens 60 may also be used in place of the shade member 50 to defocus and or redirect linear bulb output in areas corresponding to target area locations where varied irradiance is desired. The lens 60 may be fabricated from, for example, quartz material as a single piece or from a plurality of segments which co-operate to produce a desired convergence and or defocusing effect. For example, as shown in FIG. 2f, a stronger convergence at the ends compared to a convergence at the center will increase peak irradiance at either end of the target area that would otherwise be decreased due to lateral radiant loss towards either end of the linear bulb 10. In an embodiment optimized for even irradiance distribution towards either end of a longitudinal target area generally corresponding to the longitudinal dimension of a linear lamp 1, the overall length of the lens 60 may be longer than the linear bulb 10 that is being imaged.

The irradiance profile tuning techniques disclosed herein may also be applied to multiple linear lamp configurations or point sources, for example light emitting diodes. When linear lamps are configured, for example, end to end the uncorrected irradiance profile across a target area will rise in middle sections and fall towards each linear bulb end. The present invention may be applied to even out the resulting irradiance profile along the length of a desired target area of any size created by any number of energy sources.

In use, the desired irradiance profile is selected and corresponding reflector segments 40, reflectors 30, shade members 50, lens 60 and or linear bulbs 10 having appropriate surface treatments and or coatings are mounted in the linear lamp housing 20. Reflector segments 40 permit rapid and cost effective irradiance profile tuning to match a specific process demand. For example, the desired irradiance profile may be uniform across the target area, low irradiance in the middle and high irradiance at the edges of the target area or vice versa. The reflector segments 40 and or reflectors 30 may be quickly and inexpensively exchanged if they become fouled.

The present invention may also be applied to existing linear lamps 1 by replacing existing reflectors 30 and or linear bulbs 10 with reflectors 30, reflector segments 40, shade members 50, lens 60 and or linear bulbs 10 according to the invention.

Table of Parts

| | |
|---|---|
| 1 | linear lamp |
| 10 | linear bulb |
| 20 | housing |
| 30 | reflector |
| 40 | reflector segment |
| 50 | shade member |
| 60 | lens |

Where in the foregoing description reference has been made to ratios, integers, materials, components or modules having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

1. A linear lamp, comprising:
a housing,
the housing supporting
a linear bulb, and
a reflector having a first area and a second area;
the first area having a first reflectivity that is less than a second reflectivity of the second area.

2. The apparatus of claim 1, wherein the first area is located at a middle of the reflector.

3. The apparatus of claim 1, wherein the reflector has a surface pattern, the surface pattern creating the first area and the second area.

4. The apparatus of claim 3, wherein the surface pattern is formed by abrasion of a reflective surface of the reflector.

5. The apparatus of claim 3, wherein the surface pattern is a coating upon the reflector.

6. The apparatus of claim 1, wherein the reflector is a plurality of reflector segments.

7. The apparatus of claim 6, wherein at least one of the reflector segments is the first area and another of the reflector segments is the second area.

8. The apparatus of claim 6, wherein at least one of the reflector segments is formed from a different material.

9. The apparatus of claim 6, wherein at least one of the reflector segments has a surface pattern, the surface pattern creating the first area.

10. The apparatus of claim 9, wherein the surface pattern is formed by abrasion.

11. The apparatus of claim 9, wherein the surface pattern is formed by perforation.

12. The apparatus of claim 9, wherein the surface pattern is formed by a coating.

13. The apparatus of claim 12, wherein the coating is carbon black.

14. A method for adjusting the radiant output of a linear lamp having a reflector, comprising the steps of:
lowering the reflectivity of the reflector at an area corresponding to a radiant output that is higher than desired.

15. The method of claim 14, wherein the reflectivity at a middle of the reflector is lowered relative to a reflectivity at an end of the reflector.

16. The method of claim 14, wherein the reflectivity is lowered by abrading a surface of the reflector at the area.

17. The method of claim 14, wherein the reflectivity is lowered by adding a surface pattern to the area.

18. The method of claim 17, wherein the surface pattern is carbon black.

19. A linear lamp, comprising:
a housing;
the housing supporting
a linear bulb having a first end coupled to a first side coupled to a middle
coupled to a second side coupled to a second end; and
a reflector;
the linear bulb having reduced output at the middle relative to the first side and the second side.

20. The apparatus of claim 19, wherein the reduced output is formed by an abrasion of an outer surface of the middle.

21. The apparatus of claim 19, wherein the reduced output is formed by a surface pattern on an outer surface of the middle.

22. The apparatus of claim 19, wherein the reduced output is formed by a sleeve fitted over the linear bulb;
the sleeve having reduced light transmission at the middle.

23. The apparatus of claim 19, wherein the reduced output is formed by an increase of a diameter of the linear bulb at the middle.

24. The apparatus of claim 19, wherein the reduced output is formed by a first diameter of the linear bulb at the middle configured to be larger than a second diameter of the linear bulb at the first side and the second side.

25. The apparatus of claim 19, wherein the reflector has a first area and a second area;
the first area having a first reflectivity that is less than a second reflectivity of the second area.

26. A linear lamp, comprising:
a housing,
the housing supporting
a linear bulb, and
a shade member having a first shade area and a second shade area;
the first shade area having a first shade reflectivity that is less than a second shade reflectivity of the second shade area.

27. The apparatus of claim 25, further including at least one reflector having a first reflector area and a second reflector area; and
the first reflector area having a first reflector reflectivity that is less than a second reflector reflectivity of the second reflector area.

28. A linear lamp, comprising:
a housing,
the housing supporting
a linear bulb, and
a lens configured to have a convergence that varies along a longitudinal dimension of the lens.

29. The linear lamp of claim 28, wherein the lens is made of quartz.

30. The apparatus of claim 28, further including at least one reflector having a first reflector area and a second reflector area; and the first reflector area having a first reflector reflectivity that is less than a second reflector reflectivity of the second reflector area.
